(19) United States
(12) Patent Application Publication
(10) Pub. No.: US 2025/0019529 A1
(43) Pub. Date: Jan. 16, 2025

(54) MULTI-LAYER MATERIAL INCORPORATING SUSTAINABLE RESINS AND HAVING IMPROVED MECHANICAL PROPERTIES

(71) Applicant: Dura-Line LLC, Knoxville, TN (US)

(72) Inventors: Sungki Cho, Knoxville, TN (US); Arturo Valencia, Knoxville, TN (US); Sam Lukubira, Knoxville, TN (US); Jonghan Choi, Marietta, GA (US)

(73) Assignee: Dura-Line LLC, Knoxville, TN (US)

(21) Appl. No.: 18/613,472

(22) Filed: Mar. 22, 2024

Related U.S. Application Data
(60) Provisional application No. 63/454,132, filed on Mar. 23, 2023.

(51) Int. Cl. C08L 23/06; B29C 48/00; B29C 48/09; B29C 48/21; B29K 23/00

(52) U.S. Cl. CPC C08L 23/06; B29C 48/0022; B29C 48/022; B29C 48/09; B29C 48/21; B29C 2793/0045; B29K 2023/065; B29K 2995/0088; B29K 2995/0089; B29K 2995/0097; C08L 2203/18; C08L 2205/025; C08L 2207/062; C08L 2207/20

(57) ABSTRACT

A multi-layer device, such as a tube, a conduit, a tubular member, a housing, an enclosure, a fabric, a material, or any other mechanical form factor, in which at least one layer of the multi-layer device contains a mixture of a virgin high density polyethylene (HDPE) and a recycled HDPE.

### CROSS-REFERENCE TO RELATED APPLICATIONS

The application claims the benefit of U.S. provisional application Ser. No. 63/454,132, filed Mar. 23, 2023, which is incorporated herein by reference.

### BACKGROUND

Disclosed herein are multi-layer devices, such as tubes, conduit, tubular members, housings, enclosures, fabrics, materials, or any other suitable mechanical form factors, which comprise a multi-layer structure and incorporate at least one layer that comprises a mixture of a virgin high density polyethylene (HDPE) and a recycled HDPE.

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions, or is known to be relevant to an attempt to solve any problem with which this specification is concerned.

Post-consumer recycled (PCR) resins and post-industrial recycled (PIR) resins (collectively referred to herein as “sustainable resins”) are technologically deficient in mechanical and rheological properties. This state of being may be due to adverse effects occurring in the closed loop of circular value chains driven by a wide range of marketplace entities, such as compounders, converters, brand owners, retailers, consumers, waste management, and the like. In addition, as diverse feedstocks for these sustainable materials progress along the circular value chains, certain effects resulting from lack of integrity, contaminations, molecular degradations, and the like, are adversely reflected on consistency. The net effects of the above are compromised end-use performance in the field, as well as processibility on the manufacturing floor.

Due to the above-discussed deficiencies of sustainable resins, there have been certain technological limitations in their commercial use in conduit applications. Thus, there may be a desire to address these deficiencies to enable commercial use of sustainable resins that can lead to much-needed sustainability and reduction of waste products.

While certain aspects of conventional technologies have been discussed herewith to facilitate disclosure of the disclosure, this application does not disclaim these technical aspects in any way, and it is contemplated that the claimed disclosure may encompass or include one or more of the conventional technical aspects discussed herein.

### SUMMARY OF THE INVENTION

This disclosure at least partially addresses various technological problems noted above. For example, some embodiments of this disclosure may include a device, such as a tube, a conduit, a tubular member, a housing, an enclosure, a fabric, a material, or any other suitable mechanical form factor, which may contain a layer including a mixture of a virgin HDPE and a recycled HDPE.

Some embodiments may include a device comprising: a tube including a first layer, a second layer, and a third layer, wherein the first layer is innermost, wherein the third layer is outermost, wherein the second layer extends between the first layer and the third layer, wherein the first layer is solid, wherein the third layer is solid, wherein the second layer is thicker than each of the first layer and the third layer, wherein the second layer consists (i) a HDPE or (ii) a combination of the HDPE and an additive where the HDPE is a major component and the additive is a minor component, wherein the HDPE includes a virgin HDPE and a recycled HDPE, wherein the virgin HDPE has (i) a weight average molecular weight inclusively between about 200,000 grams per mole (g/mol) and about 400,000 g/mol, (ii) a toughness inclusively between about 90 megapascal (MPa) and about 150 MPa, and (iii) an impact resistance inclusively between about 140 joules per meter (J/m) at a temperature inclusively between about 15 degrees Celsius and about 30 degrees Celsius and about 180 J/m at a temperature inclusively between about 15 degrees Celsius and about 30 degrees Celsius, wherein the virgin HDPE is more dense than the recycled HDPE, wherein the recycled HDPE has (i) a weight average molecular weight equal to or less than about 150,000 g/mol, (ii) a toughness equal to or less than about 32 MPa, and (iii) an impact resistance equal to or less than about 75 J/m at a temperature inclusively between about 15 degrees Celsius and about 30 degrees Celsius, wherein the first layer is exposed to an object and the second layer is not exposed to the object when the object longitudinally extends through the tube along the first layer.

Some embodiments include a device including at least a first layer, a second layer, and a third layer, where the second layer (i) extends between the first layer and the third layer and (ii) includes a mixture of a virgin HDPE and a recycled HDPE.

Some embodiments include a method comprising: supplying a device to a user, wherein the device includes at least a first layer, a second layer, and a third layer, where the second layer (i) extends between the first layer and the third layer and (ii) includes a mixture of a virgin HDPE and a recycled HDPE.

Some embodiments include a method comprising: manufacturing a device, wherein the device includes at least a first layer, a second layer, and a third layer, where the second layer (i) extends between the first layer and the third layer and (ii) includes a mixture of a virgin HDPE and a recycled HDPE.

Some embodiments include a device including a layer including a mixture of a virgin HDPE and a recycled HDPE.

Some embodiments include a method comprising: manufacturing a device including a layer including a mixture of a virgin HDPE and a recycled HDPE.

Some embodiments include a method comprising: supplying a device to a user, wherein the device including a layer including a mixture of a virgin HDPE and a recycled HDPE.

Some embodiments include a composition comprising: a mixture of a virgin HDPE and a recycled HDPE.

Some embodiments include a method comprising: manufacturing a mixture of a virgin HDPE and a recycled HDPE.

Some embodiments include a method comprising: supplying a mixture to a user, wherein the mixture includes a virgin HDPE and a recycled HDPE.

Thus, more specifically disclosed herein is a composition of matter comprising: a first layer having a first and a second side, a second layer having a first and a second side, and a third layer having a first and a second side, wherein the second layer extends between and is in intimate contact with the first layer and the third layer such that the first side of the first layer is in face-to-face contact with the first side of the second layer, and the first side of the third layer is in face-to-face contact with the second side of the second layer; wherein the first and third layers consist essentially of a virgin thermoplastic resin; and wherein the second layer comprises virgin thermoplastic resin and recycled thermoplastic resin.

The second layer may comprise at least about 15% recycled thermoplastic resin, or at least about 30% recycled thermoplastic resin.
wherein the second layer comprises at least about 50% recycled thermoplastic resin.
wherein the wherein the first and third layers consist essentially of virgin polyethylene, and the virgin thermoplastic resin in the second layer is virgin polyethylene.
wherein the virgin polyethylene is high density polyethylene (“HDPE”) and the recycled polyethylene consists essentially of HDPE.
wherein the virgin HDPE has a weight-average molecular weight between about 200,000 g/mol to about 400,000 g/mol, a toughness between about 90 megapascal (MPa) and about 150 MPa, and an impact resistance between about 140 J/m and about 180 J/m at a temperature between about 15° C. and about 30° C.
wherein the recycled HDPE has a weight average molecular weight no greater than about 150,000 g/mol, a toughness equal to or less than about 32 MPa, and an impact resistance equal to or less than about 75 J/m at a temperature between about 15° C. and about 30° C.
wherein the first, second, and third layers are continuous and unperforated.
wherein at least one of the first, second, or third layer is perforated.
wherein the second layer is thicker than at least one of the first layer or the third layer.
wherein the second layer is thicker than both the first and the third layer.
wherein the first layer, the second layer, and the third layer each independently have a thickness of between about 10 mils and about 100 mils.
wherein the composition of matter defines a tube.

### Abbreviations and Definitions

All references to singular characteristics or limitations of the disclosed method and device shall include the corresponding plural characteristic or limitation, and vice-versa, unless otherwise specified or clearly implied to the contrary by the context in which the reference is made. The indefinite articles “a” and “an” mean “one or more.” The word “or” is used inclusively and should be read as “and/or.”

All combinations of method steps disclosed herein can be performed in any order, unless otherwise specified or clearly implied to the contrary by the context in which the referenced combination is made.

The method disclosed herein can comprise, consist of, or consist essentially of the essential elements and steps described herein, as well as any additional or optional ingredients, components, or limitations described herein or otherwise useful.

The terminology used herein can imply direct or indirect, full or partial, and/or temporary or permanent action or inaction or connectivity. For example, when an element is referred to as being “on,” “connected” or “coupled” to another element, then the element can be directly on, connected or coupled to the other element or additional intervening elements can be present between the recited elements. The same is true of the phrase “operationally connected.” Elements that are operationally connected may be directly or indirectly connected. They may be physically in contact with one another, but are not required to be so. In contrast, when an element is referred to as being “directly connected” or “directly coupled” to another element, there are no intervening elements present.

As used herein, each of terms “comprises,” “includes,” “incorporates”, “contains” and “comprising,” “including”, “incorporating”, and “containing” specify the presence of the stated features, integers, steps, operations, elements, or components, but do not preclude the presence or addition of one or more additional features, integers, steps, operations, elements, components, or groups thereof. The terms “consists of” and “consisting of” are close-ended, meaning the subsequently recited elements are present, but no other elements.

As used herein, a term “about” or “substantially” refers to a +/−10% variation from the stated variable, value, or term.

Although various terms, such as first, second, third, and so forth can be used herein to describe certain elements, components, regions, layers, or sections, note that these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section, without departing from this disclosure.

Unless otherwise defined, all terms (including technical and scientific terms) used herein have the same meaning as commonly understood by skilled artisans to which this disclosure belongs. These terms, such as those defined in commonly used dictionaries, should be interpreted as having a meaning that is consistent with their meaning in the context of the relevant technical field.

### BRIEF DESCRIPTION OF DRAWINGS

FIG. 1 is a graph showing the room-temperature toughness of the commercially available recycled HDPE polymers KWR102BM MC and UP1000HD compared to the toughness of a commercially available virgin HDPE polymer, Alathon® L4930TC. See also Table 1.

FIG. 2A is a graph showing impact resistance values of HDPE polymers KWR102BM MC. UP1000HD, and Alathon® L4930TC at room temperature. See also Table 2A.

FIG. 2B is a graph showing impact resistance values of HDPE polymers KWR102BM MC. UP1000HD, and Alathon® L4930TC at −20° C. See also Table 2B.

FIG. 3 is a graph showing the weight average molecular weight (M_{w}) of Alathon® L4930TC HDPE polymer (left-hand column in each pair) versus KWR102BM MC HDPE polymer (right-hand column in each pair) as measured using various techniques. RI=refractive index. LS=light scattering. Visco=viscometry. Triple=the combined data from light scattering for absolute molecular weights, refractive index for molecular sizes, and viscometry for intrinsic viscosity. Intrinsic viscosity in combination with molecular weight reveals essential information about a polymer's molecular structure, density, and branching.

FIG. 4 is a graph showing the number average molecular weight (Mₙ) of Alathon® L4930TC HDPE polymer (left-hand column in each pair) versus KWR102BM MC HDPE polymer (right-hand column in each pair) as measured using various techniques. Again, RI=refractive index. LS=light scattering. Visco=viscometry. Triple=the combined LS, RI, and Visco data, as noted above.

Intrinsic viscosity in combination with MW reveals essential information about a polymer's molecular structure, density, and branching.

FIG. 5 is a graph showing the polydispersity index (PDI) of Alathon® L4930TC HDPE polymer (left-hand column in each pair) versus KWR102BM MC HDPE polymer (right-hand column in each pair) as measured using various techniques. Again, RI=refractive index. LS=light scattering. Visco=viscometry. Triple=the combined LS, RI, and Visco data, as noted above.

FIG. 6A is a graph showing the enthalpy (J/g) of the virgin HDPE polymer Alathon® L4930TC. FIG. 6B is a graph showing the enthalpy (J/g) of the recycled HDPE polymer KWR102BM MC. FIG. 6C is a graph showing the enthalpy (J/g) of the recycled HDPE polymer UP1000HD.

FIG. 7 is a graph comparing the sheer ratio (sec⁻¹) of virgin Alathon® L4930TC-brand HDPE (solid circles, -•-) to recycled KWR102BM MC-brand HDPE (open circles, -∘-).

FIG. 8A shows melt flow index (“MFI”) results across a lot of virgin Alathon® L4930TC-brand HDPE. FIG. 8B shows the MFI results across a lot of recycled KWR102BM MC-brand HDPE.

FIG. 9A shows density results across a lot of virgin Alathon® L4930TC-brand HDPE. FIG. 9B shows density results across a lot of recycled KWR102BM MC-brand HDPE.

FIG. 10 is a cross-sectional, schematic diagram of a multi-layer conduit as disclosed herein.

FIG. 11 is a graph presenting the toughness of exemplary conduits made according to the present disclosure. For comparison, the far right column depicts corresponding toughness values for a single-layer conduit consisting essentially of only virgin HDPE resin. See also Table 3.

FIG. 12 is a graph depicting the toughness values for conduit made according to Comparative Examples 3 and 4, described hereinbelow.

### DETAILED DESCRIPTION OF THE INVENTION

As noted above, sustainable resins have certain technological deficiencies, such as deficiencies in mechanical and rheological properties. For example, sub-par mechanical and rheological properties of recycled resins (as compared to virgin resins) results in reduced processibility of the resins during the manufacturing process. These deficiencies also tend to adversely compromise the performance of the end-product when ultimately deployed as intended. Thus, recycled resins have not been widely deployed, for example, in conduit applications or other form factors.

Part of the problem is that recycled polymers originate from an extensive variety of sources. As a result, they have been subjected to an equally extensive variety of processing, including hygienic, thermal, and mechanical strains. Any number of industrial actors, such as compounders, converters, brand owners, retailers, consumers, waste managers, and the like, may have subsequently manipulated the resin. These actions negatively impact the mechanical and rheological properties of recycled resins. This is on top of the relatively low rate at which HDPE is recycled. In the U.S., in 2019, approximately 997.9 million pounds of HDPE was recovered for recycling. This amounts to only 19.6% of the virgin HDPE generated for use in the U.S. in 2019. (See Stina, 2019 Annual Plastic Recycling Report.) Use of post-consumer, recycled HDPE resins also present other difficulties, such as contamination of the resins with dyes, plasticizers, and other processing aids, molecular degradation from exposure to heat, sunlight, acids, bases, etc. These inconsistencies in the recycled HDPE feedstocks pose technological challenges during product development. Not surprisingly then, recycled materials are significantly compromised in their mechanical properties. The compromised mechanical properties of recycled resins result in increased failures in the field when the recycled resins are used in place of virgin resin.

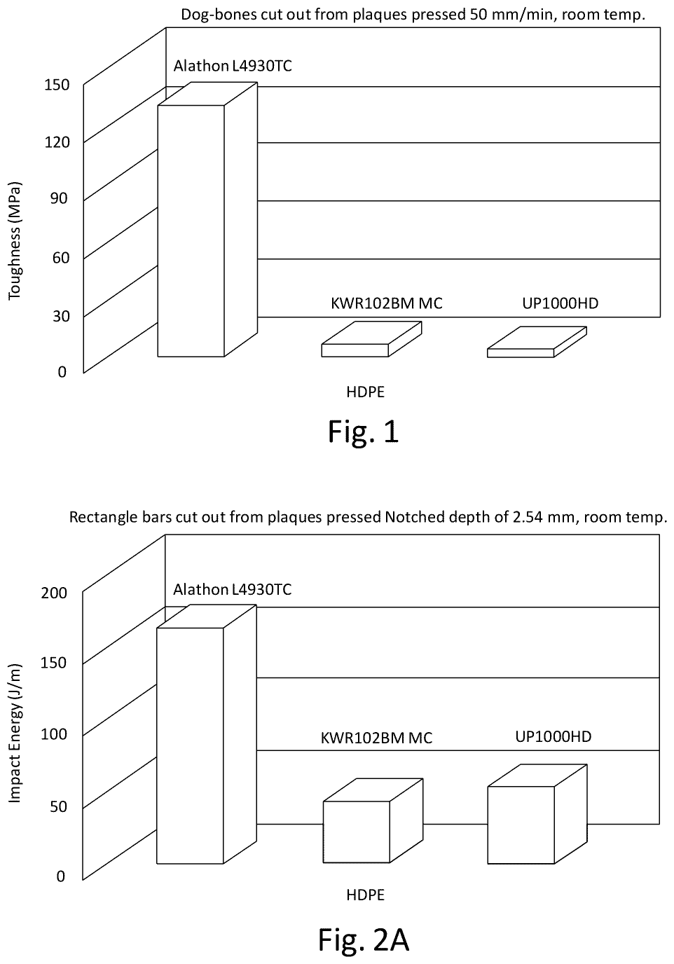

For example, as shown in FIG. 1, sustainable polymers KWR102BM MC (a mixed-color high-density polyethylene post-consumer resin available commercially from KW Plastics, Troy, Alabama, USA) and UP1000HD (a recycled, high-density polyethylene compound intended for extrusion applications, available commercially from Ultra-Poly Corporation, Portland, Pennsylvania, USA) have significantly reduced toughness at room temperature compared to the toughness value for a virgin polymer, Alathon® L4930TC conduit-grade high-density polyethylene (manufactured by LyondellBasell [headquartered in Rotterdam, Netherlands], and sold commercially in North America by Equistar Chemicals, LP, Houston, Texas, USA). The corresponding data for FIG. 1 is shown in Table 1:

TABLE 1

| | | | | SE | | | | | | |
|---|---|---|---|---|---|---|---|---|---|---|
| | HDPE | N | Mean | Mean | StDev | Min. | Q1 | Median | Q3 | Max. |
| Toughness* | Alathon | 30 | 130.5 | 2.2 | 12.1 | 98.5 | 126.5 | 132.1 | 140.9 | 147.4 |
| (MPa) | L4930TC | | | | | | | | | |
| | KWR102BM | 27 | 6.3 | 1.6 | 8.6 | 0.4 | 1.5 | 2.2 | 6.6 | 31.5 |
| | MC | | | | | | | | | |
| | UP1000HD | 30 | 3.8 | 0.8 | 4.3 | 0.1 | 0.6 | 1.4 | 6.4 | 15.8 |
| | BLK | | | | | | | | | |

*Stretch rate of 50 mm/min at room temperature on Zwick/Roell Z050 with a 50 kN load cell. See, for example, Brostow et al. (2015) Material Letters 159: 478-480.

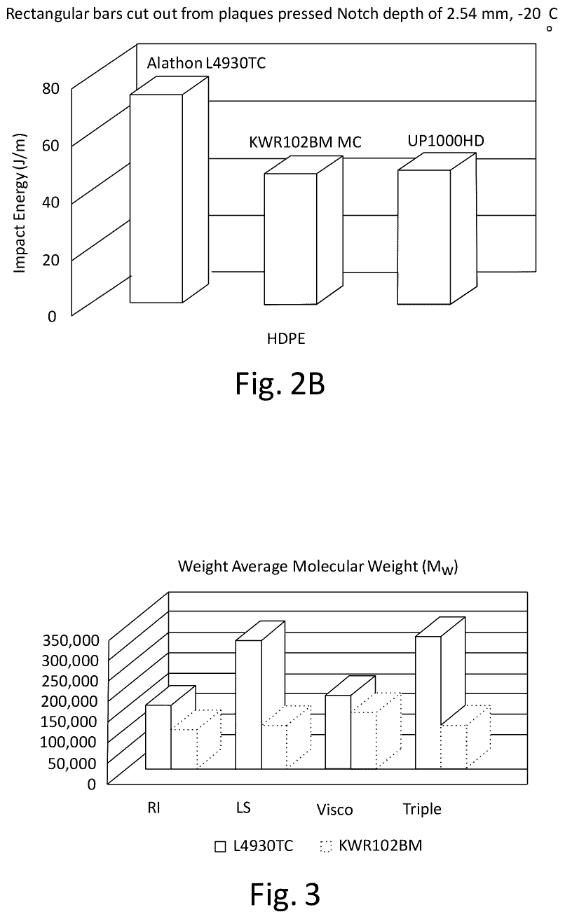

Impact resistance values of these materials show a similar trend. As shown in FIG. 2A (room temperature measurements) and 2B (measurements at −20° C.), the impact resistance of the recycled polymers is significantly lower than that of virgin polymers. The data corresponding to FIGS. 2A and 2B are shown in Table 2A and Table 2B, respectively:

TABLE 2A

| | | | | SE | | | | | | |
|---|---|---|---|---|---|---|---|---|---|---|
| | HDPE | N | Mean | Mean | StDev | Min. | Q1 | Median | Q3 | Max. |
| Impact | Alathon | 8 | 162.1 | 3.1 | 8.9 | 148.0 | 152.8 | 165.5 | 169.1 | 172.5 |
| Energy* | L4930TC | | | | | | | | | |
| (J/m) | KWR102BM | 16 | 42.3 | 1.1 | 4.3 | 37.0 | 39.2 | 41.0 | 46.8 | 50.3 |
| | MC | | | | | | | | | |
| | UP1000HD | 8 | 52.4 | 3.3 | 9.5 | 42.9 | 45.4 | 49.8 | 58.3 | 71.6 |
| | BLK | | | | | | | | | |

*Notch depth of 2.54 mm in 12.5 (E) × 3 (W) mm² specimens on Zwick/Roell HIT25P with an 11J pendulum at room temp (i.e. “Charpy impact test”). See, for example, “Impact Test,” Instron, The difference is measurable, Impact Handbook.

TABLE 2B

| | | | | SE | | | | | | |
|---|---|---|---|---|---|---|---|---|---|---|
| | HDPE | N | Mean | Mean | StDev | Min. | Q1 | Median | Q3 | Max. |
| Impact | Alathon | 10 | 73.6 | 4.7 | 15.0 | 56.8 | 59.3 | 70.8 | 86.5 | 101.1 |
| Energy* | L4930TC | | | | | | | | | |
| (J/m) | KWR102BM | 20 | 45.6 | 1.7 | 7.9 | 32.1 | 39.7 | 46.4 | 51.6 | 64.9 |
| | MC | | | | | | | | | |
| | UP1000HD | 10 | 46.6 | 2.4 | 7.8 | 36.4 | 41.0 | 43.8 | 54.3 | 60.4 |
| | BLK | | | | | | | | | |

*Notch depth of 2.54 mm in 12.5 (E) × 3 (W) mm² specimens on Zwick/Roell HIT25P with an 11J pendulum at −20° C.

The sizable reduction in toughness seen in FIG. 1 can be directly attributed to reduced molecular weights of the recycled HDPE, resulting from the molecular degradations that inevitable occur in the recycling process.

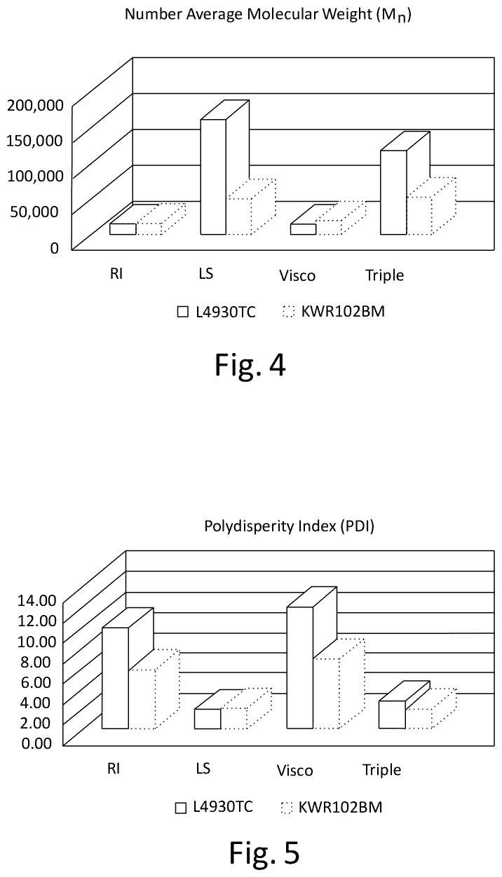

The weight average (M_{w}) and number average (Mₙ) molecular weights of the recycled and virgin polymers were also analyzed. The results are shown in FIG. 3 (weight average molecular weight) and FIG. 4 (number average molecular weight). The polydispersity index (PDI) of the polymers is shown in FIG. 5. The weight average and number average molecular weights were measured using various techniques, including refractive index, light scattering, viscometry, and the combination of these three (i.e., “Triple”).

As seen from FIGS. 1 through 5, not only does the molecular degradation adversely affect the mechanical properties, the degradation also negatively affects rheological properties. This results a cascading string of negative outcomes. The degraded rheological properties have a negative impact on melt stability. The instability in the recycled polymers when melted results in inconsistent processibility, which unequivocally results in lower yields and productivity.

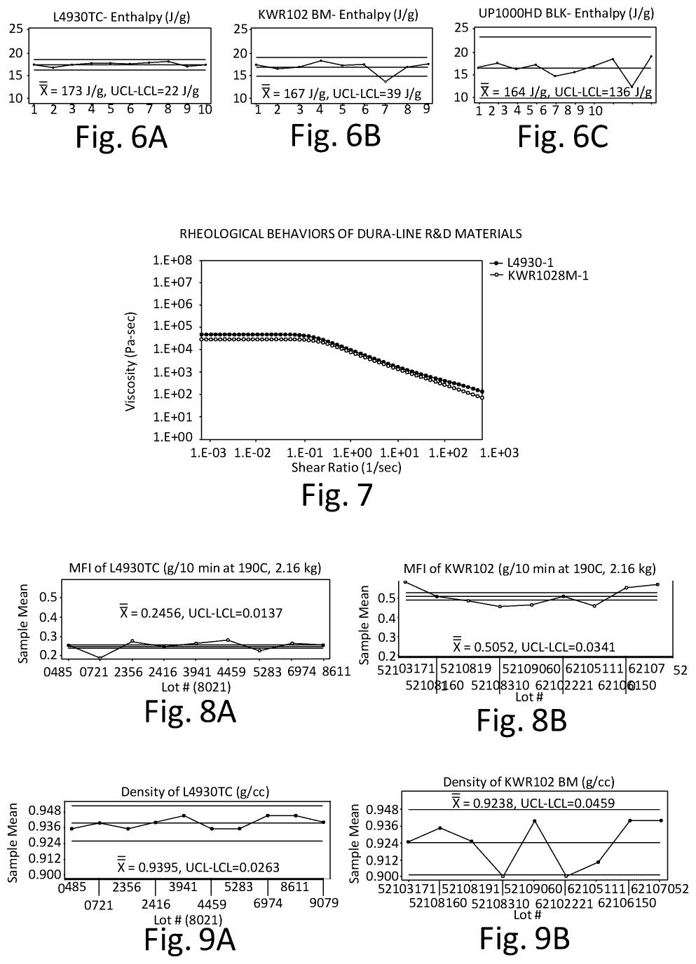

The lack of consistency in processability is further exacerbated by the sheer diversity of the recycled feedstocks themselves. As the raw feedstocks of these recycled materials are collected, chipped, combined, and then re-introduced into the market, it is perhaps inevitable that the lack of material uniformity would adversely impact processing consistency. To elucidate variations in the sustainable and virgin polymers, enthalpy, one of the measures of inherent thermal properties, was determined over multiple lots. FIGS. 6A, 6B, and 6C show that tolerance of enthalpy is much greater for the sustainable HDPE than for the virgin HDPE, apart from lower enthalpy. Compare FIG. 6A, which shows the enthalpy (J/g) of the virgin HDPE polymer Alathon® L4930TC, to FIGS. 6B and 6C, which show the enthalpy of the recycled HDPE polymers KWR102BM MC and UP1000HD, respectively.

Recycled polymers exhibit variations in still other physical characteristics as compared to virgin polymers. Again, these variations and inconsistencies trickle down to adversely impact the quality of conduit (or any other final product) that includes these materials. Additional data showing differences in the rheological and inherent physical properties of sustainable and virgin polymers are shown in FIGS. 7 through 9B.

FIG. 7 is a graph comparing the sheer ratio (sec⁻¹) of virgin Alathon® L4930TC-brand HDPE to recycled KWR102BM MC-brand HDPE. As is seen in the figure, the two traces are distinctly different. Insofar as sheer ratio impacts extrusion, the differences are problematic for consistent extrusion of conduit when using recycled materials.

FIGS. 8A (virgin HDPE) and 8B (recycled HDPE) show melt flow index (MFI) results for samples of HDPE taken from the same lot. FIG. 8A shows the MFI results for virgin Alathon® L4930TC-brand HDPE. FIG. 8B shows the MFI results for recycled KWR102BM MC-brand HDPE. In both graphs, the MFI was taken at 190° C., with 2.16 kg of pressure applied to the melt. The results are reported in the conventional measure of g/10 min (i.e., the mass in grams of the melted polymer that flowed through the capillary in 10 minutes). Also reported in the figures is the upper control limit (UCL) minus the lower control limit (LCL) for each dataset, along with x̅ (i.e., the average of the averages for each sample tested). As can be seen in comparing FIG. 8A (virgin HDPE) versus FIG. 8B (recycled HDPE), UCL-LCL for the virgin polymer is far smaller (0.0137) than UCL-LCL for the recycled polymer (0.0341). This means that the melt flow index for the virgin polymer is far more consistent across the bulk of the lot than is the corresponding melt flow index of the recycled polymer. The practical outcome is that the difference in MFI will result in an increased variability (i.e., decreased consistency) when extruding recycled HDPE versus when extruding virgin HDPE.

Similar results are seen in the variability of the density across a lot of virgin HDPE versus a lot of recycled HDPE. See FIGS. 9A and 9B. FIG. 9A shows the density results for virgin Alathon® L4930TC-brand HDPE. FIG. 9B shows the density results for recycled KWR102BM MC-brand HDPE. Here, the differences are quite striking. Again, the figures present the upper control limit (UCL) minus the lower control limit (LCL) for each dataset, along with x̅ (i.e., the average of the averages for each sample tested). As can be seen in comparing FIG. 9A (virgin HDPE) versus FIG. 9B (recycled HDPE), UCL-LCL for the virgin polymer is far smaller (0.0263) than UCL-LCL for the recycled polymer (0.0459). This means that the density for the virgin polymer is far more consistent across the bulk of the lot than is the corresponding density of the recycled polymer. Again, the practical outcome is that the difference in density will result in increased variability (i.e., decreased consistency) when extruding recycled HDPE versus when extruding virgin HDPE.

As disclosed herein, these deficiencies in the processing of recycled polymers can be mitigated by incorporating the recycled resins into multi-layered conduit (or other form factors disclosed herein) configurations, wherein the ultimate mechanical properties of the multi-layered conduit (or other form factors disclosed herein) are superior to the mechanical properties of a single-layer or multi-layer conduit configurations consisting solely of virgin polymers or consisting solely of recycled polymers. For example, recycled resins can be included in single-layer or multi-layered conduit (or other form factors disclosed herein) configurations, such as micro-ducts (MDs), conduits, pipes, housings, enclosures, tubes, tubular members, cylinders, multi-dimensional volumes, and the like (without limitation), without compromising their respective end-use performance, while also making such configurations more sustainable because they use recycled materials.

For sake of brevity only, the following discussion will use the word “conduit” as a catch-all phrase to cover the various form factors disclosed in the immediately preceding paragraph, i.e., micro-ducts, conduits, pipes, housings, enclosures, tubes, tubular members, cylinders, multi-dimensional volumes, and the like, without limitation.

The composition of matter disclosed herein comprises recycled polymeric resins and virgin (e.g., fresh or freshly prepared) polymeric resins to counter these technological deficiencies. Any thermoplastic resin (both recycled and virgin) can be used, without limitation. Thermoplastic resin is defined broadly herein to include (by way of example and not limitation): poly(aklylenes) such as polyethylene, polypropylene, and the like, polycarbonates, polyacrylics, polyamides, polystyrenes, thermoplastic co-polymers such as ABS (Acrylonitrile Butadiene Styrene), polyesters, and the like. In general, high-density polyethylene (“HDPE”) is preferred. Again, for sake of brevity only, HDPE is used herein to denote high-density polyethylene itself, and any other recyclable thermoplastic resin, without limitation.

The virgin and recycled polymers may be incorporated into the conduit via chemistry-based approaches, such as by blending or mixing the virgin and recycled polymers together to yield a uniform polymeric composition comprising both virgin and recycled molecules that are intimately associated with one another at the molecular level. Alternatively, the virgin and recycled polymers can be associated with one another at a macro-scale, structure-based level as in multilayer constructions.

Certain adverse physical characteristics of the recycled resins may be attenuated by combining the recycled resins with virgin polymers to form a polymer blend, mixture, or composition containing both recycled and virgin polymers, with no additional ingredients or in combination or admixture with others compositions, blends, and the like. Additionally, in the multi-layer conduit configuration, a central (or non-central) layer containing the polymer blend, mixture, or composition may be surrounded or enclosed within layers that consist of or consist essentially of virgin polymers.

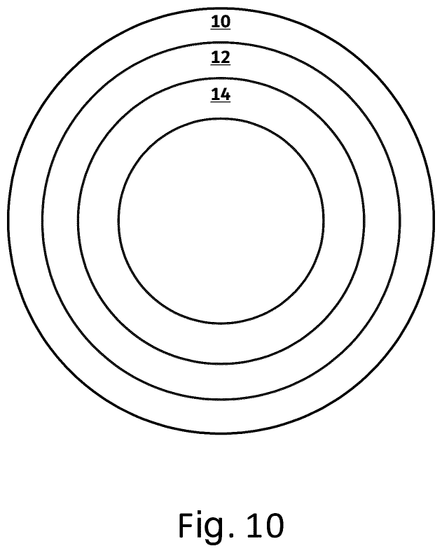

An illustrative example of such a multi-layer conduit configuration is shown in FIG. 10. Referring to FIG. 10, the middle layer 12 is the layer that comprises, consists essentially of, or consists of the recycled polymer. That it, the middle layer 12 may consist of or consist essentially of a recycled thermoplastic polymer. Alternatively, the middle layer 12 may comprise a recycled thermoplastic polymer in the form of a polymer blend, polymer mixture, or any other polymer composition comprising recycled thermoplastic polymer and virgin thermoplastic polymer. In the preferred version of the conduit, the inner layer 14 and the outer layer 10 sandwiching the middle layer 12 are layers that consist essentially of virgin polymer (with or without any number of conventional additives such as dyes, plasticizers, fillers, etc. know in the art). These inner (14) and outer (10) layers containing the virgin polymer may function to physically protect the middle layer (12) from physical and chemical damage that might occur due to layer 12 containing recycled material.

Some versions of the composition of matter may involve a form factor (e.g., a tube, a conduit) including a first layer (e.g., plastic, polymer, metal, metal alloy, rubber, wood, HDPE, virgin HDPE, recycled HDPE), a second layer, and a third layer (e.g., plastic, polymer, metal, metal alloy, rubber, wood, HDPE, virgin HDPE, recycled HDPE). The first layer and the third layer may, as shown in numerals 10 and 14 in FIG. 10, be structurally or chemically identical or non-identical. The second layer (12 In FIG. 10) extends between the first layer and the third layer. For example, the second layer may be interposed between the first layer and the third layer (as layer 12 is interposed between layers 10 and 14 in FIG. 10). The various layers may be of the same thickness or of different thicknesses. For example, the second layer may be thicker or thinner (e.g., edge to edge) than the first layer and/or the third, etc. But this is not required. All of the layers of the construct may be of the same or different thicknesses.

The device may include a fourth layer (e.g., plastic, polymer, metal, metal alloy, rubber, wood, HDPE, virgin HDPE, recycled HDPE), a fifth layer (e.g., plastic, polymer, metal, metal alloy, rubber, wood, HDPE, virgin HDPE, recycled HDPE), a sixth layer (e.g., plastic, polymer, metal, metal alloy, rubber, wood, HDPE, virgin HDPE, recycled HDPE), or more layers, which may or may not be thicker, thinner, or be identical in thickness to the first layer, the second layer, or the third layer. For example, the fourth layer, the fifth layer, or the sixth layer may or may not extend, which includes interposing, between the first layer and the third layer or the first layer and the second layer or the third layer and the second layer. For example, at least one of the first layer, the second layer, or the third layer may be a single layer or a set of layers forming a single layer. For example, the fourth layer, the fifth layer, or the sixth layer may be a single layer or a set of layers forming a single layer. The first layer may or may not be innermost. The third layer may or may not be outermost. The first layer may be solid and unbroken in any way such that the second layer may be protected or isolated by the first layer. However, this configuration is not required and the first layer may be perforated. Likewise, the third layer may be solid and unbroken such that the second layer may be protected or isolated by the third layer. However, this configuration is not required and the third layer may be perforated.

When the device takes the form of a tube, a duct, or a conduit, then the tube, duct, or the conduit may be weather-proof or water-proof or weather-resistant or water-resistant. For example, the tube, duct, or the conduit may be buried below ground (e.g., soil) or deposited on a floor of a body of water (e.g., a river, a lake, a sea, an ocean). For example, the tube, the duct, or the conduit may house or convey cables, wires, ropes, fiber optic cables, electrical cables, fluids (liquids or gases), or other materials, whether used in telecommunications, electrical, medical, vehicular transportation, consumer products, construction, projectile barrels, missiles, rockets, trains, or fluid transportation industries. For example, the tube, duct, or the conduit may be used for housing and routing fiber optic cables, electrical cables (or wires, ropes, chains, lines, or other elongated items), data cables (or wires, ropes, chains, lines, or other elongated items), fluids (e.g., liquids, gases), or other objects, whether used in telecommunications, electrical, medical, vehicular transportation, consumer products, construction, projectile barrels, missiles, rockets, trains, or fluid transportation industries. For example, the tube, duct, or conduit may be included in aerostructures, wings, tails, ailerons, winglets, boats, submarines, ships, missiles, automotive frontal grills, car panels, windshields, wheels, tires, rollers, medical tubing, swallowable medical devices, implantable medical devices, rain-resistant or rain-proof clothing or shoes, snow-blower augers, cutting blades, door or cabinet hinges, pads, gauze, fabrics, or other objects. For example, the tube, duct, or the conduit may be used for housing and routing cables (or wires, ropes, chains, lines, or other elongated items), water (or other fluids or liquids or gases), or other objects, whether natural or artificial. For example, the tube, duct, or the conduit may be used to transport, pass, guide, convey a solid (e.g., objects, cables, chains, ropes, beads, particulates, powders, boxes), a sludge, or a fluid (e.g., liquid, gas, steam, water, alcohol, edible, non-edible, gasoline, oil) including electronic and telecommunication wires and fiber optics, singly or in plural, and which may be sheathed or unsheathed; water; aqueous and non-aqueous solvents and solutions; alcohol; alcohol-based solvents and solutions; inert and non-inert gases; or others. This transport, pass, guide, convey may be through or along a surface (e.g., inner, outer) that is coated, uncoated, structured, or configured, as disclosed herein.

Some embodiments may include a device comprising a tube including a first layer, a second layer, and a third layer, wherein the first layer is innermost, wherein the third layer is outermost, wherein the second layer extends between the first layer and the third layer, wherein the first layer is solid, wherein the third layer is solid, wherein the second layer is thicker than each of the first layer and the third layer, wherein the second layer consists (i) a high density polyethylene (HDPE) or (ii) a combination of the HDPE and an additive where the HDPE is a major component and the additive is a minor component, wherein the HDPE includes a virgin HDPE and a recycled HDPE, wherein the virgin HDPE has (i) a weight average molecular weight inclusively between about 200,000 grams per mole (g/mol) and about 400,000 g/mol, (ii) a toughness inclusively between about 90 megapascal (MPa) and about 150 MPa, and (iii) an impact resistance inclusively between about 140 joules per meter (J/m) at a temperature inclusively between about 15 degrees Celsius and about 30 degrees Celsius and about 180 J/m at a temperature inclusively between about 15 degrees Celsius and about 30 degrees Celsius, wherein the virgin HDPE is more dense than the recycled HDPE, wherein the recycled HDPE has (i) a weight average molecular weight equal to or less than about 150,000 g/mol, (ii) a toughness equal to or less than about 32 MPa, and (iii) an impact resistance equal to or less than about 75 J/m at a temperature inclusively between about 15 degrees Celsius and about 30 degrees Celsius, wherein the first layer is exposed to an object and the second layer is not exposed to the object when the object longitudinally extends through the tube along the first layer.

A particularly favored version of the device comprises at least a first layer, a second layer, and a third layer, where the second layer extends between the first layer and the third layer and comprises a mixture of a virgin HDPE and a recycled HDPE. In this favored version, the first and third layers may also consist essentially of virgin HDPE (or other virgin thermoplastic polymer resin). Here, the term “consist[s] essentially of” does not exclude conventional additives such as plasticizers, inks, dyes, release agents, and the like, that are used with thermoplastic polymers generally and HDPE specifically, but it does exclude the presence of recycled polymer resin.

Also disclosed herein is a method of supplying a device to a user. The device includes at least a first layer, a second layer, and a third layer, where the second layer extends between the first layer and the third layer, the second layer comprises a mixture of a virgin HDPE and a recycled HDPE, and the first and third layers consist essentially of virgin HDPE (or other virgin thermoplastic polymer resin).

Likewise disclosed herein is a method of manufacturing a device, wherein the device includes at least a first layer, a second layer, and a third layer, where the second layer extends between the first layer and the third layer, the second layer comprises a mixture of a virgin HDPE and a recycled HDPE, and the first and third layers consist essentially of virgin HDPE (or other virgin thermoplastic polymer resin). The method comprising bringing into intimate, face-to-face contact a first face of the first layer with a first face of the second layer, and a first face of the third layer with a second face of the second layer, such that the second layer is sandwiched between or encapsulated by the first and third layers. Any of the three layers may be continuous or perforated (uniformly or non-uniformly). The method can be accomplished via co-extrusion of the first, second, and third layers, or via lamination of the first, second, and third layers in a suitable lamination press.

By way of example and not limitation, Table 3 summarizes a series of conduits fabricated according to the present disclosure. Here, the inner layer (i.e., layer 12 in FIG. 10) was fabricated using a polymer blend comprising virgin HDPE (Alathon® L4930TC-brand HDPE) and recycled HDPE (KWR102BM MC-brand HDPE). The inner and outer layers (layers 10 and 14 in FIG. 10) were fabricated using a polymer consisting essentially of virgin HDPE polymer (Alathon® L4930TC-brand HDPE) The inner layer of each exampled used a blend ratio of virgin and recycled polymer resin (by weight) as stated in the right-hand columns of Table 3. The thickness of each layer (in % of total wall thickness) is also presented. Each three-layered conduit construction had an outer diameter of 1¼″ and a total wall thickness of 92.6 mil, which yields a Standard Dimension Ratio (SDR) of 13.5. (The SDR is the ratio of pipe diameter to wall thickness: SDR=D/s, wherein D=pipe outside diameter and s=wall thickness.)

TABLE 3

| | | Configuration | | | | |
|---|---|---|---|---|---|---|
| | | Layer Thickness (% of total wall thickness) | | | Blend Ratio (wt %) | |
| Run | | Inner | Middle | Outer | KWR102 | L4930 |
| Candidate | 154 | 15 | 35 | 50 | 16 | 84 |
| | 155 | 24 | 26 | 50 | 15 | 85 |
| | 156 | 15 | 35 | 50 | 33 | 67 |
| | 157 | 27 | 23 | 50 | 33 | 67 |
| Additional | 158 | 12 | 35 | 53 | 16 | 84 |
| | 159 | 12 | 26 | 62 | 15 | 85 |
| | 160 | 12 | 35 | 53 | 33 | 67 |
| | 161 | 12 | 23 | 65 | 33 | 67 |

| | | |
|---|---|---|
| Control | Single-layer | L4930 |

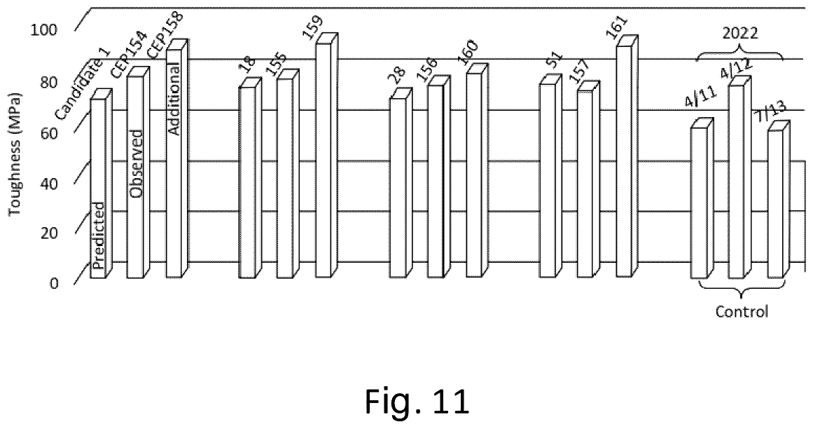

FIG. 11 is a graph tabulating the toughness of the conduits described in Table 3. The Controls presented in the far-right column in FIG. 11 are single-layer conduits that include only virgin polymers. All the other conduits for which data is presented in FIG. 11 were three-layered conduits incorporating a recycled polymer in the middle layer (i.e., in layer 12 as shown in FIG. 10). In each group of three bars, the left-hand bar presents the statistically predicted toughness (MPa) values for the three-layered conduits. The middle bar in each group is the respective, experimentally determined toughness value for each exemplary conduit. The right-hand bar in each group of three i the experimentally determined toughness values for conduits that have thicker outer layers to provide further reinforcement of the conduit configuration. As demonstrated by the results in Table 3, the toughness of the three-layered conduits are fairly comparable to the control. Referring to FIG. 11, the toughness values of the three-layered conduits with thicker outer layers (CEP158-161 in Table 3) consistently exceeds the toughness values of the control conduits. These data reveal that the multi-layered conduits disclosed herein have superior mechanical properties to virgin-polymer only conduits, even though they comprise a substantial amount of recycled resin.

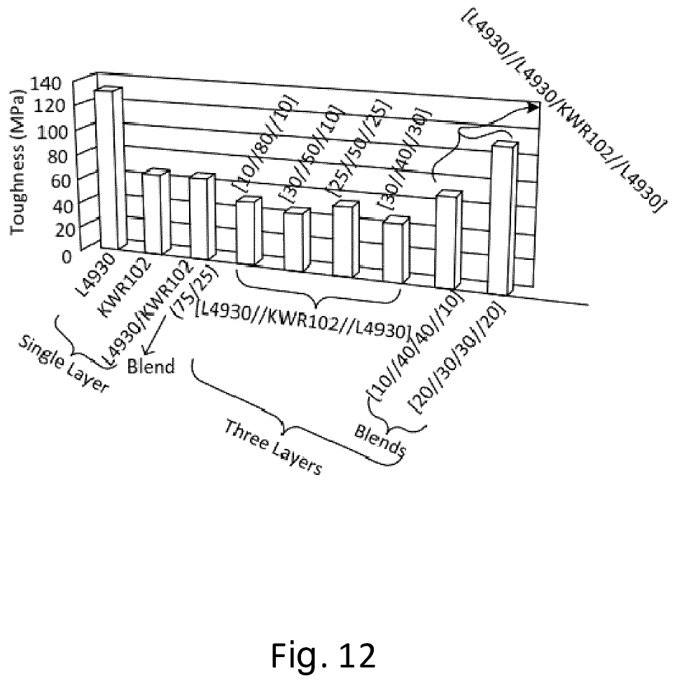

To further identify effects of layer thicknesses and (a) symmetry in the 1¼″, three-layer conduits, different configurations were investigated each varying thicknesses by percentage such as [10//80//10] (Outer//Middle//Inner, mils) (Comparative Example 1), [30//60//10](Comparative Example 2), [25//50//25] (Comparative Example 3), and [30//40//30](Comparative Example 4). The corresponding toughness data is shown in FIG. 12. As seen from FIG. 12, a symmetrical construction did not yield any noticeable difference in toughness. Compare the toughness values of Comparative Example 4, having a [30//60//10] configuration, to the toughness values of Comparative Examples 1 to 3, each of which have equal thicknesses of the inner and outer layers.

In the following examples, the middle layer of the three-layer construction includes a blend of the virgin and sustainable HDPE at 50/50 by wt % sheathed between the virgin HDPE layers of 10% and 20% in thickness by percentage, respectively, in a symmetric manner, resulting in the configurations of [10//80 (40/40 wt %)//10] (Example 1) and [20//60 (30/30 wt %)//20] (Example 2). Referring again to FIG. 12, the toughness values of the conduits of Examples 1 and 2 are shown by entries 3, 8 and 9 in FIG. 12. As seen from the results in FIG. 12, the conduits of both Examples 1 and 2 exceeded all others in toughness except the one exclusively employing the virgin HDPE (˜139 MPa) (control, bar on far left side of FIG. 12). These data clearly demonstrate that the conduits (or other form factors disclosed herein) that (i) incorporate a polymer blend of sustainable polymers and virgin polymers; and (ii) have a multi-layer configuration have unexpected and superior mechanical and rheological properties compared to conduits (or other form factors disclosed herein) that include solely a polymer blend or a multi-layer configuration. It should also be noted that the three-layer (or two-layer or four layer or five layer) conduit (or other form factors disclosed herein) with the thicker inner/outer layers may have higher toughness values, for example, ˜111 MPa for conduits having a 20% increased thickness of the outer layer compared to the blended middle layer vs. ˜70 MPa for conduits having a 10% increased thickness of the outer layer compared to the blended middle layer. This is a result of the enhanced reinforcement of the weakest link in the configuration, i.e., the blended middle layer, with the thicker, virgin HDPE inner/outer layers.

It is contemplated by the present disclosure that the blended or mixed middle layer comprising the recycled polymer in combination with the virgin polymer, whether with or not with an additive where the HDPE is a major component and the additive is a minor component, can be as thick as technically tolerable, which may in turn be translatable into the thinnest possible inner/outer layers that can still deliver acceptable processibility and end-use product performance.

The blend or mix ratio of the sustainable polymer to the virgin polymer may or may not be limited, and can be any suitable blend or mix ratio that allows for the incorporation of the highest suitable amount of the sustainable polymer in the resin blend, while maintaining the unexpected and superior mechanical and rheological properties of the conduits that meet acceptable product and process requirements.

Various measurement techniques were used to measure the mechanical and rheological properties of the constituent polymers and resulting conduits including, but not limited to, melt flow index (MFI), density, and environmental stress-cracking resistance (ESCR).

MFI provides snapshot information on rheological properties, and is used to differentiate various HDPE grades such as extrusion, blow molding, injection molding, and the like. In addition, MFI can be used for quality control on various internal and external masterbatches (MB). The testing conditions to measure MFI are most commonly stated as temperature/load, and a 190° C./2.16 kg for the majority of HDPE resins and MBs according to ASTM D1238 has been conventionally used. One of the expected and prevalent deficiencies of the sustainable HDPE resins is molecular degradation, and MFI may provide a speedy verdict on the severity of any such molecular degradation resulting from strenuous life cycles of the sustainable polymers prior to incorporation into the resin blend of the present disclosure.

The density of HDPE ranges from about 0.93 g/cm³ to about 0.97 g/cm³, which is an insightful measure of inherent properties of the material. The density data of the incoming, sustainable HDPE resins may be used to determine whether to release such sustainable resins to production.

ESCR is frequently employed as a surrogate test method to predict longevity of materials/products, in an expedited manner. Due to its inherent nature of the abusive and harsh environment in which test specimens are placed, ESCR lends itself to evaluating integrity of the incoming, sustainable HDPE resins and thus can be effectively utilized to determine their suitability against criteria currently being in development.

As various changes could be made in the above methods and compositions without departing from the scope of the disclosure, it is intended that all matter contained in the above description shall be interpreted as illustrative and not in a limiting sense. Any numbers expressing quantities of ingredients, constituents, reaction conditions, and so forth used in the specification are to be interpreted as encompassing the exact numerical values identified herein, as well as being modified in all instances by the term “about.” Notwithstanding that the numerical ranges and parameters setting forth the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. § 112, paragraph 6, unless the term “means” is explicitly used.

1. A composition of matter comprising:
a first layer having a first and a second side, a second layer having a first and a second side, and a third layer having a first and a second side, wherein the second layer extends between and is in intimate contact with the first layer and the third layer such that the first side of the first layer is in face-to-face contact with the first side of the second layer, and the first side of the third layer is in face-to-face contact with the second side of the second layer;
wherein the first and third layers consist essentially of a virgin thermoplastic resin; and
wherein the second layer comprises virgin thermoplastic resin and recycled thermoplastic resin.

2. The composition of matter of claim 1, wherein the second layer comprises at least about 15% recycled thermoplastic resin.

3. The composition of matter of claim 1, wherein the second layer comprises at least about 30% recycled thermoplastic resin.

4. The composition of matter of claim 1, wherein the second layer comprises at least about 50% recycled thermoplastic resin.

5. The composition of matter of claim 1, wherein the wherein the first and third layers consist essentially of virgin polyethylene, and the virgin thermoplastic resin in the second layer is virgin polyethylene.

6. The composition of matter of claim 5, wherein the virgin polyethylene is high density polyethylene (“HDPE”) and the recycled polyethylene consists essentially of HDPE.

7. The composition of matter of claim 6, wherein the virgin HDPE has a weight-average molecular weight between about 200,000 g/mol to about 400,000 g/mol, a toughness between about 90 megapascal (MPa) and about 150 MPa, and an impact resistance between about 140 J/m and about 180 J/m at a temperature between about 15° C. and about 30° C.

8. The composition of matter of claim 6, wherein the recycled HDPE has a weight average molecular weight no greater than about 150,000 g/mol, a toughness equal to or less than about 32 MPa, and an impact resistance equal to or less than about 75 J/m at a temperature between about 15° C. and about 30° C.

9. The composition of matter of claim 1, wherein the first, second, and third layers are continuous and unperforated.

10. The composition of matter of claim 1, wherein at least one of the first, second, or third layer is perforated.

11. The composition of matter of claim 1, wherein the second layer is thicker than at least one of the first layer or the third layer.

12. The composition of matter of claim 1, wherein the second layer is thicker than both the first and the third layer.

13. The composition of matter of claim 1, wherein the first layer, the second layer, and the third layer each independently have a thickness of between about 10 mils and about 100 mils.

14. The composition of matter of claim 1, wherein the composition of matter defines a tube.

15. A composition of matter comprising:
a first layer having a first and a second side, a second layer having a first and a second side, and a third layer having a first and a second side, wherein the second layer extends between and is in intimate contact with the first layer and the third layer such that the first side of the first layer is in face-to-face contact with the first side of the second layer, and the first side of the third layer is in face-to-face contact with the second side of the second layer;
wherein the first and third layers consist essentially of a virgin high density polyethylene resin; and
wherein the second layer comprises virgin thermoplastic high density polyethylene resin and recycled high density polyethylene resin;
wherein the virgin HDPE has a weight-average molecular weight between about 200,000 g/mol to about 400,000 g/mol, a toughness between about 90 megapascal (MPa) and about 150 MPa, and an impact resistance between about 140 J/m and about 180 J/m at a temperature between about 15° C. and about 30° C.; and
the recycled HDPE has a weight average molecular weight no greater than about 150,000 g/mol, a toughness equal to or less than about 32 MPa, and an impact resistance equal to or less than about 75 J/m at a temperature between about 15° C. and about 30° C.

16. The composition of matter of claim 15, wherein the first, second, and third layers are continuous and unperforated.

17. The composition of matter of claim 15, wherein at least one of the first, second, or third layer is perforated.

18. The composition of matter of claim 15, wherein the second layer is thicker than at least one of the first layer or the third layer.

19. The composition of matter of claim 15, wherein the second layer is thicker than both the first and the third layer.

20. The composition of matter of claim 15, wherein the first layer, the second layer, and the third layer each independently have a thickness of between about 10 mils and about 100 mils.

21. The composition of matter of claim 15, wherein the composition of matter defines a tube.
